(19) United States
(12) Patent Application Publication
(10) Pub. No.: US 2006/0104521 A1
(43) Pub. Date: May 18, 2006

(54) Image processing devices and methods

(76) Inventor: Shu-Wen Teng, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/989,108

(22) Filed: Nov. 15, 2004

(51) Int. Cl. G06K 9/36

(52) U.S. Cl. 382/232

(57) ABSTRACT

Image processing devices. A motion estimation processor generates an image block according to video data. A forward discrete cosine transform module transforms the image block to a discrete cosine transformed data block segmented into a plurality of first transformed data segments, and outputs the first transformed data segments in sequence. A quantizer separately quantizes the transformed data segments and generates a quantized data block using the separately quantized data segments. An inverse quantizer separately dequantizes the quantized data segments and generates a dequantized data block using the separately dequantized data segments. An inverse discrete cosine transform module transforms the dequantized data block to an inverse discrete cosine transformed data block segmented into a plurality of second transformed data segments, and outputs the second transformed data segments in sequence.

### BACKGROUND

The present disclosure relates in general to image processing. In particular, the present disclosure relates to image processing devices and methods for Moving Picture Experts Group (MPEG) coding/decoding (codec).

MPEG-4 is a video compression standard for transmission and manipulation of video data in multimedia environments. MPEG is used in many current and emerging products, including digital television set-top boxes, digital satellite systems (DSS), high-definition television (HDTV) decoders, digital versatile disk (DVD) players, video conferencing, internet video, and other applications. These applications benefit from video compression as less storage space is required for archiving video. Moreover, less bandwidth is required for video transmission.

FIG. 1 shows a conventional image compressing device. In FIG. 1, the device includes DCT operator 13 for calculating discrete cosine transform (DCT) coefficients from input image data, and quantizer 14 for quantizing the DCT coefficients. The device also includes inverse quantizer 15, inverse DCT operator 16, adder 17, switching logic units 12 and 19, and subtracter 11, all of which form a feedback line for the quantized DCT coefficients. The device additionally includes image memory 18 for extracting motion vector V. In addition, the device further includes coding controller 10 for controlling quantizer 14 and switching logic units 12 and 19.

DCT operator 13 can process image input data of N×N size. A DCT process in the conventional image compressing device is explained with respect to FIG. 2, a block diagram showing a configuration of a DCT operator employing a conventional row-column decomposition method. The row-column decomposition uses characteristics of the DCT kernel to decrease the number of multiplication operations. After the row-column decomposition, DCT operator 13 outputs the transformed N×N data block to quantizer 14.

In row-column decomposition, after the input N×N image data passes through a first-orientation DCT operator 131 in rows, the result thereof is temporarily stored in a transposition memory 132. Then, after reading the result in columns, a DCT operation is executed through a second-orientation DCT operator 133 in columns. Because the DCT operator also employs various fast algorithms to enhance overall performance, the number of multipliers used in the entire DCT operation is decreased.

FIG. 3 is a timing chart of a conventional image compression method, using an 8×8 image block as an example. In the conventional row-column decomposition of the DCT process, quantization of the DCT coefficients of the quantizer is enabled after the DCT operator performs the first-orientation DCT operation and the second-orientation DCT operation with the entire 8×8 image block. In addition, the dequantizer is enabled after the quantization of the DCT coefficients for the 8×8 image block. After the dequantizer outputs the dequantized result, the IDCT operator starts inverse DCT operation. As shown in FIG. 3, the DCT operator, the quantizer, the dequantizer, and the IDCT operator operate individually in different phases.

### SUMMARY

Image processing devices and methods are provided. An embodiment of an image processing device for processing an image block segmented into a plurality of first data segments arranged in a first orientation, comprises: a forward discrete cosine transform module operative to transform the first data segments in sequence to generate a first transformed data block segmented into a plurality of first transformed data segments arranged in a second orientation, transform the first transformed data segments in sequence to generate a plurality of second transformed data segments arranged in the second orientation, and output the second transformed data segments in sequence.

Another embodiment of an image processing device for processing an image block segmented into a plurality of first data segments arranged in a first orientation, comprises: a forward discrete cosine transform module operative to transform the first data segments in sequence to generate a first transformed data block segmented into a plurality of first transformed data segments arranged in a second orientation, transform the first transformed data segments in sequence to generate a plurality of second transformed data segments arranged in the second orientation, and output the second transformed data segments in sequence; a quantizer operative to separately quantize the second transformed data segments and generate quantized data segments in sequence; an inverse quantizer operative to separately dequantize the quantized data segments and generate dequantized data segments in sequence; an inverse discrete cosine transform module operative to transform the dequantized data segments in sequence to generate a second transformed data block segmented into a plurality of third transformed data segments arranged in the first orientation, transform the third transformed data segments in sequence to generate a plurality of fourth transformed data segments arranged in the first orientation, and output the fourth transformed data segments in sequence.

Another embodiment of an image processing device, comprises: a motion estimation processor operative to generate an image block according to video data; a forward discrete cosine transform module operative to transform the image block to a discrete cosine transformed data block segmented into a plurality of first transformed data segments, and output the first transformed data segments in sequence; a quantizer operative to separately quantize the transformed data segments and generate a quantized data block using the separately quantized data segments; an inverse quantizer operative to separately dequantize the quantized data segments and generating a dequantized data block using the separately dequantized data segments; an inverse discrete cosine transform module operative to transform the dequantized data block to an inverse discrete cosine transformed data block segmented into a plurality of second transformed data segments, and output the second transformed data segments in sequence.

An embodiment of an image processing method, comprises: providing an image block segmented into a plurality of first data segments arranged in a first orientation; discrete cosine transforming the first data segments in sequence to generate a first transformed data block segmented into a plurality of first transformed data segments arranged in a second orientation, and the first transformed data segments in sequence to generate a plurality of second transformed data segments arranged in the second orientation; outputting the second transformed data segments in sequence; separately quantizing the second transformed data segments to generate quantized data segments in sequence; separately dequantizing the quantized data segments to generate dequantized data segments in sequence; inverse discrete cosine transforming the dequantized data segments in sequence to generate a second transformed data block segmented into a plurality of third transformed data segments arranged in the first orientation, and the third transformed data segments in sequence to generate a plurality of fourth transformed data segments arranged in the first orientation; outputting the fourth transformed data segments in sequence; and outputting the fourth transformed data segments in sequence.

Another embodiment of an image processing device, comprises: means for providing an image block segmented into a plurality of first data segments arranged in a first orientation; means for discrete cosine transforming the first data segments in sequence to generate a first transformed data block segmented into a plurality of first transformed data segments arranged in a second orientation, and the first transformed data segments in sequence to generate a plurality of second transformed data segments arranged in the second orientation; means for outputting the second transformed data segments in sequence; means for separately quantizing the second transformed data segments to generate quantized data segments in sequence; means for separately dequantizing the quantized data segments to generate dequantized data segments in sequence; means for inverse discrete cosine transforming the dequantized data segments in sequence to generate a second transformed data block segmented into a plurality of third transformed data segments arranged in the first orientation, transforming the third transformed data segments in sequence to generate a plurality of fourth transformed data segments arranged in the first orientation, and outputting the fourth transformed data segments in sequence; means for outputting the fourth transformed data segments in sequence.

### DESCRIPTION OF THE DRAWINGS

The invention will become more fully understood from the detailed description, given hereinbelow, and the accompanying drawings. The drawings and description are provided for purposes of illustration only and, thus, are not intended to be limiting of the present invention.

FIG. 1 shows a conventional image compressing device.

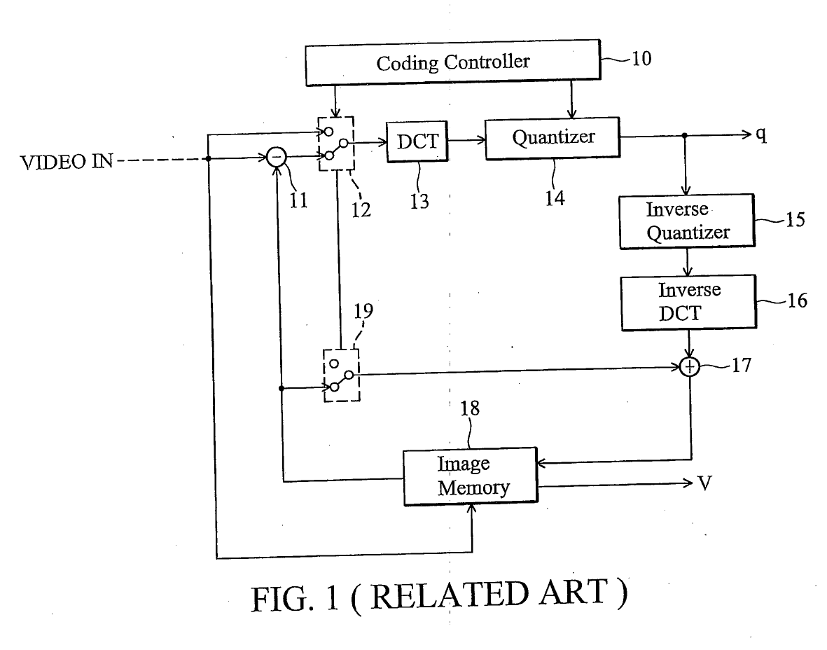

FIG. 2 is a block diagram showing a configuration of a DCT operator employing a conventional row-column decomposition method.

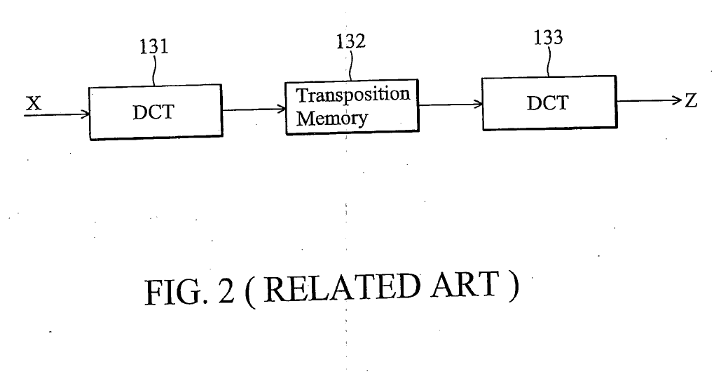

FIG. 3 is a timing chart of a conventional image compression method.

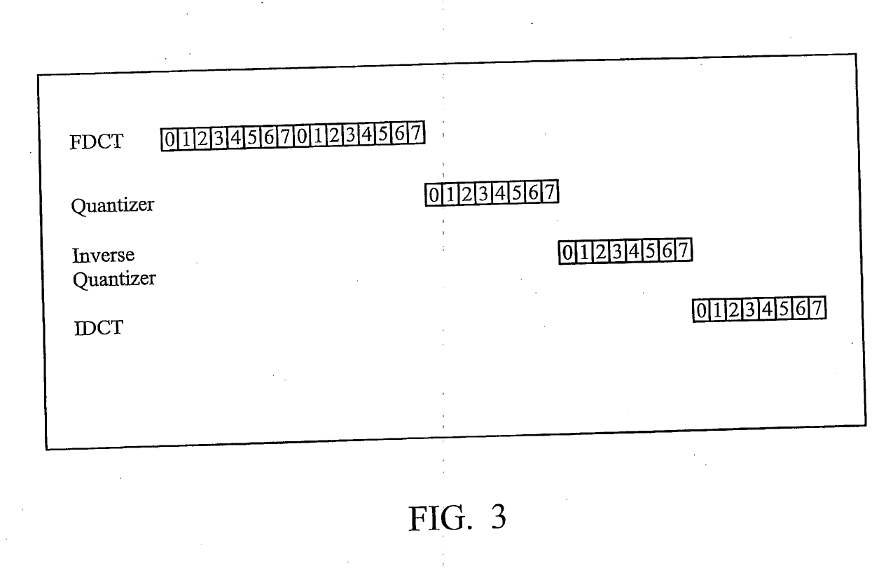

FIG. 4 is a schematic diagram of an embodiment of an image encoding device.

FIG. 5 is a schematic diagram of another embodiment of an image encoding device.

FIG. 6 is a flowchart of an embodiment of an image compression method.

FIG. 7 is a timing chart of an embodiment of image compression method.

### DETAILED DESCRIPTION

MPEG devices and methods are provided for processing video codec for input of video data with MPEG compression algorithms. Such MPEG compression algorithms includes MPEG-1, MPEG-2 and MPEG-4 standards.

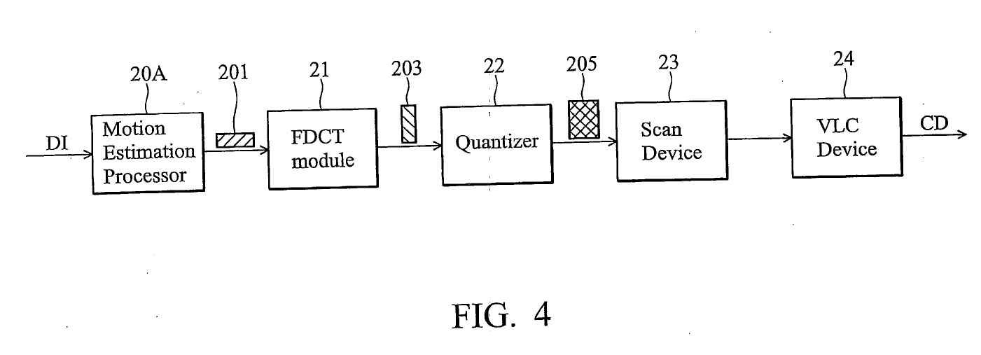

FIG. 4 is a schematic diagram of an embodiment of an image encoding device. The image encoding device comprises a motion estimation processor 20A, forward discrete cosine transform (FDCT) module 21, quantizer 22, scan device 23, and variable-length coding (VLC) device 24.

Motion estimation processor 20A generates an N×N image block according to video data DI. The N×N image block is segmented into a plurality of image segments 201. In some embodiments, motion estimation processor 20A may output a single N×N image block to FDCT module 21. In some embodiments, motion estimation processor 20A may output the image segments 201 in sequence to FDCT module 21.

FDCT module 21 performs discrete cosine transform for the received data. The discrete cosine transform is closely related to the discrete Fourier transformation (FFT) and, as such, allows data to be represented in terms of its frequency components. In some embodiments, FDCT module 21 performs discrete cosine transformation by row-column decomposition for the received data. If the data received by FDCT module 21 is the N×N image block, N×N image block is transformed by the first-orientation DCT operation in rows, and the transformed block is read in columns, then the read column data segment is transformed by the second-orientation DCT. After one column data segment is transformed by the second-orientation DCT, FDCT module 21 outputs the transformed column data segment 203 to quantizer 22 in sequence. In some embodiments, the first orientation and the second orientation are perpendicular. In some embodiments, the first orientation is a row orientation and the second orientation is a column-orientation.

If the data received by FDCT module 21 is image segment 201, the received image segment 201 is transformed by the first-orientation DCT in rows. After all image segments 201 of the NxN image block are transformed by first-orientation DCT, the transformed data is read in columns. The read column data segment is then transformed by the second-orientation DCT. After one column data segment is transformed by the second-orientation DCT, FDCT module 21 outputs the transformed column data segment 203 to quantizer 22. In some embodiments, FDCT module 21 combines the received image segments into the N×N image block, and transforms the combined image block as described.

Quantizer 22 reduces the amount of information required to represent the frequency bins of the column data segments 203 by converting amplitudes in certain ranges to one in a set of quantization levels. Different quantization is applied to each coefficient depending on the spatial frequency within the block that it represents. Usually, increased quantization error can be tolerated in high-frequency coefficients, because high-frequency noise is less visible than low-frequency quantization noise. In some embodiments, the quantizer 22 separately quantizes the transformed column data segments 203 and generates a quantized data block 205 using the separately quantized data segments.

After quantization, the quantized data block 205 with DCT coefficients is scanned by scan device 23 in a predetermined direction. For example, the quantized data block 205 can be scanned in a zigzag scanning pattern or others, to transform the 2-D array into a serial string of quantized coefficients. The coefficient strings produced by the zigzag scanning are coded by counting the number of zero coefficients preceding a non-zero coefficient, i.e. run-length coding, and Huffman coding. The run-length value and the value of the non-zero coefficient, which the run of zero coefficients precedes, are then combined and coded using variable-length coding (VLC) device 24 to generate compressed data CD. VLC device 24 exploits the fact that short runs of zeros are more likely than long ones, and small coefficients are more likely than large ones. The VLC allocates codes have different lengths, depending upon the expected frequency of occurrence of each zero-run-length/non-zero coefficient value combination. Common combinations use short code words; less common combinations use long code words. All other combinations are coded by the combination of an escape code and two fixed length codes, one 6-bit word to indicate the run length, and one 12-bit word to indicate the coefficient value.

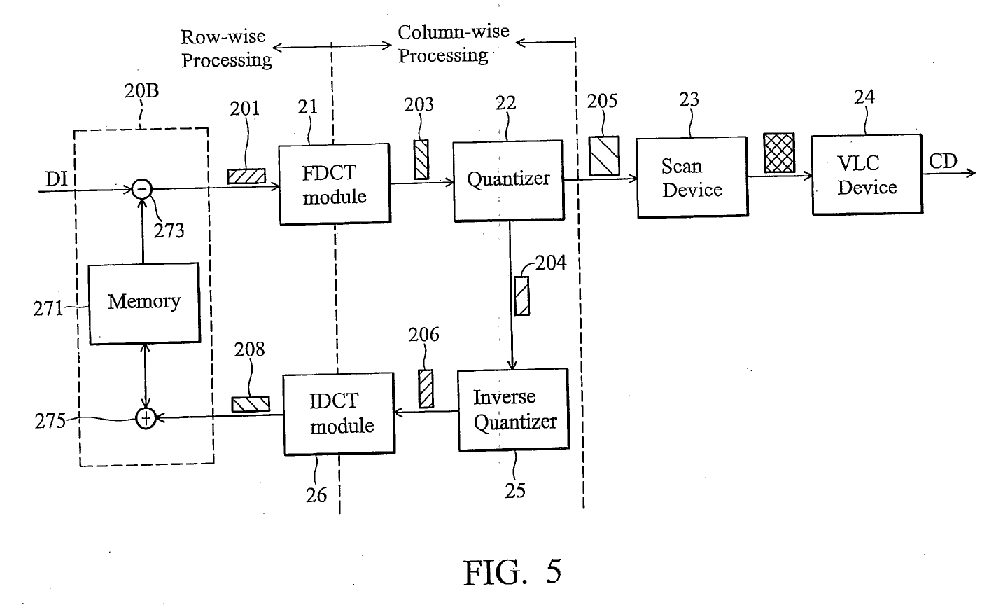

FIG. 5 is a schematic diagram of another embodiment of an image encoding device. In FIG. 5, the elements corresponding to those in FIG. 4 share the same reference numerals, and explanation thereof is omitted to simplify the description.

In FIG. 5, a feedback loop between motion estimation processor 20B and quantizer 22 is added. The feedback loop comprising inverse quantizer 25 and inverse DCT module 26.

Motion estimation processor 20B comprises memory 271, subtracter 273 and adder 275. Memory 271 stores reference data. Subtracter 273 obtains a difference between the input video data DI and the reference data. Adder 275 adds the reference data and output data of IDCT module 26, and updates the reference data in memory 271 by the adding result. In some embodiments, motion estimation processor 20B determines a compression mode for the video data DI according to the difference between the video data DI and the reference data.

Quantizer 22 separately quantizes the transformed column data segments 203 and generates a quantized data block 205 using the separately quantized data segments 204. In some embodiments, quantized data segment 204 can be column data of quantized data block 205.

Inverse quantizer 25 separately dequantizes the quantized data segments 204, generates corresponding dequantized data segments 206, and outputs dequantized data segments 206 to IDCT module 26 in sequence. The dequantized data segments 206 comprises a dequantized data block. In some embodiments, dequantized data segment 206 can be column data of the dequantized data block.

IDCT module 26 receives the dequantized data segments 206 in sequence, performing inverse discrete cosine transformation by row-column decomposition for dequantized data segments 206. The dequantized data segments 206, which are column data segments of the dequantized data block, is transformed by the first-orientation inverse DCT operation in column, and the transformed block is read in rows, then the read row data segment is transformed by the second-orientation inverse DCT. After one row data segment is transformed by the second-orientation inverse DCT, IDCT module 26 outputs the transformed row data segment 208 to motion estimation processor 20B in sequence. In some embodiments, transformed data segment 208 is added to reference data by adder 275, then, the adding result updates the data stored in memory 271.

As FDCT module 21 and IDCT module 26 both perform row-column decomposition in row-orientation and column-orientation, the FDCT module 21 can perform row-column decomposition in row-orientation first, then in column-orientation, and IDCT module 26 perform row-column decomposition in column-orientation first, then in row-orientation. Thus, data segments input to FDCT module 21 are row data segments, and data segments output from FDCT module 21 are column data segments. In addition, data segments input to IDCT module 26 are column data segments, and data segments output from IDCT module 26 are row data segments. Thus, data processing after FDCT module 21 is in column data segments, and after IDCT module 26 in row data segments. Thus, the pipeline units become 8 elements from the 8×8 data block, and each function block outputs 8 executed units to the next phase without waiting for all 8×8 units, thus decreasing data process time.

As shown in FIG. 5, data segment 201 transmitted between motion estimation processor 20B and FDCT module 21 is a row data segment, data segment 208 transmitted between IDCT module 26 and motion estimation processor 20B is a row data segment, data segment 203 transmitted between FDCT module 21 and quantizer 22 is a column data segment, data segment 203 transmitted between FDCT module 21 and quantizer 22 is a column data segment, data segment 204 transmitted between quantizer 22 and inverse quantizer 25 is a column data segment, and data segment 206 transmitted between inverse quantizer 25 and IDCT module 26 is a column data segment. In addition, the row data segment 208 output from IDCT module 26 and video data DI are simultaneously input to motion estimation processor 20B, achieving data parallelization.

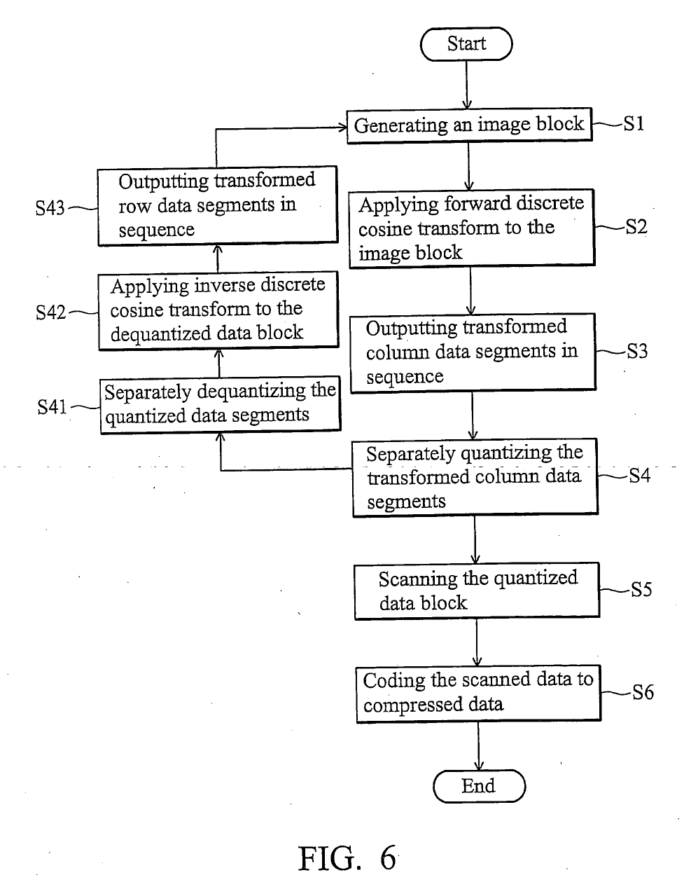

FIG. 6 is a flowchart of an embodiment of an image compression method. First, an image block is generated according to input video data and reference data (S1). Next, a discrete cosine transformed data block segmented into a plurality of transformed column data segments are generated by applying forward discrete cosine transform (DCT) to the image block using row-column decomposition (S2). The image block is transformed by the first-orientation DCT operation in rows, and the transformed block is read in columns, then the read column data segment is transformed by the second-orientation DCT. After one column data segment is transformed by the second-orientation DCT, the transformed column data segments are output in sequence (S3). At step S4, the transformed column data segments are separately quantized. The quantized data segments form a quantized data block. Then, the quantized data block is scanned and transformed to serial string data (S5). Next, the serial string data is transformed by variable-length coding into compressed data (S6).

In addition, there is a feedback loop between steps S4 and S1. The quantized data segments generated in step S4 are separately dequantized to dequantized data segments (S41). The dequantized data segments form a dequantized data block. Next, an inverse discrete cosine transformed data block segmented into a plurality of transformed row data segments is generated by applying inverse discrete cosine transform to the dequantized data block (S42). The dequantized data block is transformed by the first-orientation inverse DCT operation in columns, and the transformed block is read in rows, then the read row data segment is transformed by the second-orientation inverse DCT. After one row data segment is transformed by the second-orientation inverse DCT, the transformed row data segments are output in sequence (S43) for the reference of generating the image block in step S1.

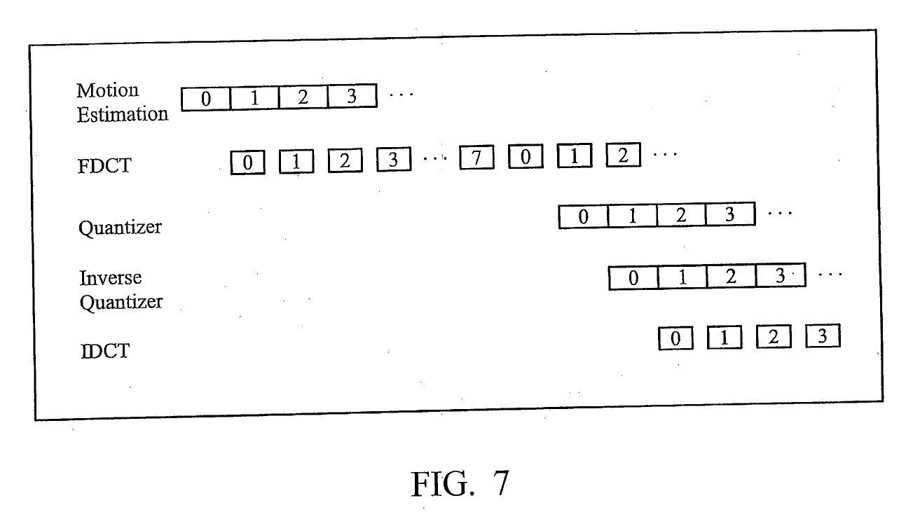

FIG. 7 is a timing chart of an embodiment of an image compression method, using an 8×8 image block as an example. As shown in FIG. 7, quantization of the DCT coefficients of the quantizer is enabled when a data segment is generated by the DCT operator during the second-orientation DCT operation, without waiting for the DCT operator to finish transformation with the entire 8×8 image block. In addition, the dequantizer is enabled after quantization of the DCT coefficients for one data segment of the 8×8 image block. After the dequantizer outputs the dequantized result, the IDCT operator starts inverse DCT operation. As shown in FIG. 7, the DCT operator, the quantizer, the dequantizer, and the IDCT operator may synchronized operate, decreasing image processing time.

Accordingly, elements of the embodiment DCT-based image processing device depicted simultaneously process part of the data block without awaiting processing results of the last phase. For example, with an 8×8 image block, the FDCT module outputs a transformed data segment (8 data elements) to the quantizer. Unlike conventional FDCT modules that do not output data until after transformation of all 8×8 data elements, the quantizer quantizes the transformed data segment earlier, decreasing performance latency. Additionally, the pipeline of data transmission before entering the FDCT module can be by row data segments, and by column data segments between FDCT module and IDCT module, then by row data unit after performed by IDCT unit. Thus, the pipeline data size is decreased and data parallelization is achieved, which may improve performance.

The foregoing description of several embodiments have been presented for the purpose of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An image processing device for processing an image block segmented into a plurality of first data segments arranged in a first orientation, comprising:
a forward discrete cosine transform module operative to transform the first data segments in sequence to generate a first transformed data block segmented into a plurality of first transformed data segments arranged in a second orientation, transform the first transformed data segments in sequence to generate a plurality of second transformed data segments arranged in the second orientation, and output the second transformed data segments in sequence.

2. The image processing device as claimed in claim 1, further comprising:
an inverse discrete cosine transform module operative to receive the second transformed data segments in sequence, transform the second data segments in sequence to generate a second transformed data block segmented into a plurality of third transformed data segments arranged in the first orientation, transform the third transformed data segments in sequence to generate a plurality of fourth transformed data segments arranged in the first orientation, and output the fourth transformed data segments in sequence.

3. The image processing device as claimed in claim 1, wherein a discrete cosine transformed data block is generated by the forward discrete cosine transform module using the second transformed data segments.

4. The image processing device as claimed in claim 2, wherein an inverse discrete cosine transformed data block is generated by the inverse discrete cosine transform module using the fourth transformed data segments.

5. The image processing device as claimed in claim 1, wherein the first orientation and the second orientation are perpendicular.

6. The image processing device as claimed in claim 1, wherein the first orientation is a row orientation.

7. The image processing device as claimed in claim 6, wherein the second orientation is a column orientation.

8. The image processing device as claimed in claim 1, wherein the first orientation is a column orientation.

9. The image processing device as claimed in claim 8, wherein the second orientation is a row orientation.

10. The image processing device as claimed in claim 2, wherein the first data segments, the third transformed data segments, and the fourth transformed data segments are row data segments.

11. The image processing device as claimed in claim 1, wherein the first transformed data segment, and the second transformed data segment are column data segments.

12. An image processing device for processing an image block segmented into a plurality of first data segments arranged in a first orientation, comprising:
a forward discrete cosine transform module operative to transform the first data segments in sequence to generate a first transformed data block segmented into a plurality of first transformed data segments arranged in a second orientation, transform the first transformed data segments in sequence to generate a plurality of second transformed data segments arranged in the second orientation, and output the second transformed data segments in sequence;
a quantizer operative to separately quantize the second transformed data segments and generate quantized data segments in sequence;
an inverse quantizer operative to separately dequantize the quantized data segments and generate dequantized data segments in sequence; and
an inverse discrete cosine transform module operative to transform the dequantized data segments in sequence to generate a second transformed data block segmented into a plurality of third transformed data segments arranged in the first orientation, transform the third transformed data segments in sequence to generate a plurality of fourth transformed data segments arranged in the first orientation, and output the fourth transformed data segments in sequence.

13. The image processing device as claimed in claim 12, wherein a quantized data block is generated by the quantizer using the separately quantized data segments.

14. The image processing device as claimed in claim 12, wherein a discrete cosine transformed data block is generated by the forward discrete cosine transform module using the second transformed data segments.

15. The image processing device as claimed in claim 12, wherein an inverse discrete cosine transformed data block is generated by the inverse discrete cosine transform module using the fourth transformed data segments.

16. The image processing device as claimed in claim 13, further comprising:
a scan device operative to scan the quantized data block and transform the quantized data block into serial string data; and
a variable-length coding device operative to variable-length encode the serial string data to generate compressed data.

17. The image processing device as claimed in claim 12, wherein the first orientation and the second orientation are perpendicular.

18. The image processing device as claimed in claim 12, wherein the first orientation is a row orientation.

19. The image processing device as claimed in claim 18, wherein the second orientation is a column orientation.

20. The image processing device as claimed in claim 12, wherein the first orientation is a column orientation.

21. The image processing device as claimed in claim 20, wherein the second orientation is a row orientation.

22. The image processing device as claimed in claim 12, wherein the first data segment, the third transformed data segment, and the fourth transformed data segment are row data segments.

23. The image processing device as claimed in claim 12, wherein the first transformed data segment, the second transformed data segment, the quantized data segment, and the dequantized data segment are column data segments.

24. The image processing device as claimed in claim 12, further comprising a motion estimation processor operative to generate the image block according to video data.

25. The image processing device as claimed in claim 24, wherein the motion estimation processor comprises:
a memory operative to store reference data;
a subtracter operative to obtain a difference between the video data and the reference data; and
an adder operative to add the reference data and the fourth transformed data segment, and update the reference data in the memory.

26. An image processing device, comprising:
a motion estimation processor operative to generate an image block according to video data;
a forward discrete cosine transform module operative to transform the image block to a discrete cosine transformed data block segmented into a plurality of first transformed data segments, and outputt the first transformed data segments in sequence;
a quantizer operative to separately quantize the transformed data segments and generating a quantized data block using the separately quantized data segments;
an inverse quantizer operative to separately dequantize the quantized data segments and generating a dequantized data block using the separately dequantized data segments; and
an inverse discrete cosine transform module operative to transform the dequantized data block to an inverse discrete cosine transformed data block segmented into a plurality of second transformed data segments, and output the second transformed data segments in sequence.

27. The image processing device as claimed in claim 26, wherein the image block is segmented into a plurality of image segments, and the motion estimation processor outputs the image segments in sequence.

28. The image processing device as claimed in claim 26, wherein the forward discrete cosine transform module combines the image segments to the image block.

29. The image processing device as claimed in claim 26, further comprising:
a scan device operative to scan the quantized data block, and transform the quantized data block into serial string data; and
a variable-length coding device operative to variable-length encode the serial string data to generate compressed data.

30. The image processing device as claimed in claim 26, wherein the inverse quantizer outputs the dequantized data segments in sequence.

31. The image processing device as claimed in claim 26, wherein the inverse discrete cosine transform module combines the dequantized data segments to the dequantized data block.

32. The image processing device as claimed in claim 26, wherein the motion estimation processor comprises:
a memory operative to store reference data;
a subtracter operative to obtain a difference between the video data and the reference data; and
an adder operative to add the reference data and the second transformed data segment, and update the reference data in the memory.

33. The image processing device as claimed in claim 26, wherein the first transformed data segment is column data of the transformed data block.

34. The image processing device as claimed in claim 26, wherein the quantized data segment is column data of the quantized data block.

35. The image processing device as claimed in claim 26, wherein the image segment is row data of the image block.

36. The image processing device as claimed in claim 26, wherein the dequantized data segment is column data of the dequantized data block.

37. The image processing device as claimed in claim 26, wherein the second transformed data segment is row data of the inverse discrete cosine transformed data block.

38. An image processing method, comprising:
providing an image block segmented into a plurality of first data segments arranged in a first orientation;
discrete cosine transforming the first data segments in sequence to generate a first transformed data block segmented into a plurality of first transformed data segments arranged in a second orientation, the first transformed data segments in sequence to generate a plurality of second transformed data segments arranged in the second orientation, and outputting the second transformed data segments in sequence;
separately quantizing the second transformed data segments to generate quantized data segments in sequence;
separately dequantizing the quantized data segments to generate dequantized data segments in sequence;
inverse discrete cosine transforming the dequantized data segments in sequence to generate a second transformed data block segmented into a plurality of third transformed data segments arranged in the first orientation, and the third transformed data segments in sequence to generate a plurality of fourth transformed data segments arranged in the first orientation, and outputting the fourth transformed data segments in sequence; and
outputting the fourth transformed data segments in sequence.

39. The image processing method as claimed in claim 38, further comprising:
scanning the quantized data block and transforming the quantized data block into serial string data; and
variable-length encoding the serial string data to generate compressed data.

40. The image processing method as claimed in claim 38, wherein the first orientation and the second orientation are perpendicular.

41. The image processing method as claimed in claim 38, wherein the first orientation is a row orientation.

42. The image processing device as claimed in claim 41, wherein the second orientation is a column orientation.

43. The image processing method as claimed in claim 38, wherein the first data segments, the third transformed data segments, and the fourth transformed data segments are row data segments.

44. The image processing method as claimed in claim 38, wherein the first transformed data segments, the second transformed data segments, the quantized data segments, and the dequantized data segments are column data segments.

45. The image processing method as claimed in claim 38, further comprising:
storing reference data;
obtaining a difference between the video data and the reference data; and
updating the reference data by adding the reference data and the fourth transformed data segment.

46. An image processing device, comprising:
means for providing an image block segmented into a plurality of first data segments arranged in a first orientation;
means for discrete cosine transforming the first data segments in sequence to generate a first transformed data block segmented into a plurality of first transformed data segments arranged in a second orientation, and the first transformed data segments in sequence to generate a plurality of second transformed data segments arranged in the second orientation;
means for outputting the second transformed data segments in sequence;
means for separately quantizing the second transformed data segments to generate quantized data segments in sequence;
means for separately dequantizing the quantized data segments to generate dequantized data segments in sequence;
means for inverse discrete cosine transforming the dequantized data segments in sequence to generate a second transformed data block segmented into a plurality of third transformed data segments arranged in the first orientation, and the third transformed data segments in sequence to generate a plurality of fourth transformed data segments arranged in the first orientation
means for outputting the fourth transformed data segments in sequence; and
means for outputting the fourth transformed data segments in sequence.

47. The image processing device as claimed in claim 46, further comprising:
means for scanning the quantized data block and transforming the quantized data block into serial string data; and
means for variable-length encoding the serial string data to generate compressed data.

48. The image processing device as claimed in claim 46, wherein the first orientation and the second orientation are perpendicular.

49. The image processing device as claimed in claim 46, wherein the first orientation is a row orientation.

50. The image processing device as claimed in claim 49, wherein the second orientation is a column orientation.

51. The image processing device as claimed in claim 46, wherein the first data segments, the third transformed data segments, and the fourth transformed data segments are row data segments.

52. The image processing device as claimed in claim 46, wherein the first transformed data segments, the second transformed data segments, the quantized data segments, and the dequantized data segments are column data segments.

53. The image processing device as claimed in claim 46, further comprising:
storing reference data;
obtaining a difference between the video data and the reference data; and
updating the reference data by adding the reference data and the fourth transformed data segment.
